(19) United States
(12) Patent Application Publication
(10) Pub. No.: US 2020/0185910 A1
(43) Pub. Date: Jun. 11, 2020

(54) METHODS AND APPARATUS FOR CONTROLLING IN-RUSH CURRENT DURING DYNAMIC CONTEXT SWITCHING

(71) Applicant: SEMICONDUCTOR COMPONENTS INDUSTRIES, LLC, Phoenix, AZ (US)

(72) Inventor: Bart CREMERS, Zonhoven (BE)

(73) Assignee: SEMICONDUCTOR COMPONENTS INDUSTRIES, LLC, Phoenix, AZ (US)

(21) Appl. No.: 16/215,075

(22) Filed: Dec. 10, 2018

(51) Int. Cl. H02H 9/00; G05F 1/575; H04N 5/369

(52) U.S. Cl. CPC H02H 9/001; H04N 5/3698; G05F 1/575

(57) ABSTRACT

An image sensor may contain an array of imaging pixels arranged in rows and columns. To support lower speed operation while minimizing power consumption, the image sensor may alternate between a high power context and a low power context. When transitioning between the high power and low power contexts, an in-rush current limiting circuit may be used to slowly ramp up or ramp down the bias current to help minimize power supply voltage rippling. The in-rush current limiting circuit may be digitally controlled using a current ramping digital-to-analog converter, may implement linear current ramping, or may implement a current feedback ramping scheme.

### BACKGROUND

This relates generally to image sensors and more particularly, to image sensors that employ dynamic power context switching.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light and not as admissions of prior art.

Modern electronic devices such as cellular telephones, cameras, and computers often use digital image sensors. Image sensors (sometimes referred to as imagers) may be formed from a two-dimensional array of image sensing pixels. The array of image sensing pixels are typically arranged in pixel rows and columns. Each pixel includes a photosensitive layer that receives incident photons (light) and converts the photons into electrical charge. Column sensing circuitry is typically coupled to each pixel column for reading out image signals from the image pixels.

Typical image capture operations aim to reduce power consumption when operating at a lower speed. For a rolling shutter image sensor where a still picture or a video frame is not captured by taking a snapshot of the entire frame but rather by scanning across the frame rapidly in a row-by-row fashion, one way to reduce power consumption is to keep the readout pace (or “line rate”) identical to the full-speed mode but to turn off the analog bias current in between two read cycles. Effectively, this introduces low power “dummy lines” to fill up the increased frame time.

The rolling shutter readout pointer should overlap with the high-power state. During the dummy lines, the image sensor can be switched to a lower-power state. The transition between the high-power state and the low-power state is sometimes referred to as “dynamic power context switching.” However, depending on the selected integration time, the rolling integration start time could potentially overlap the high-power and/or low-power states. The effects on the power supply network during a dynamic power context switching event can be quite detrimental and can oftentimes result in spikes and ringing. As a result, a dark reference level can inadvertently be sampled by the pixels during integration.

It is within this context that the embodiments described herein arise.

### BRIEF DESCRIPTION OF THE DRAWINGS

FIG. 1 is a diagram of an illustrative electronic device in accordance with an embodiment.

FIG. 2 is a diagram of an illustrative image pixel array in an image sensor in accordance with an embodiment.

FIG. 3 is a diagram illustrating dynamic power context switching in accordance with an embodiment.

FIG. 4 is a timing diagram illustrating dynamic power context switching.

FIG. 5 is a timing diagram illustrating how the power supply network can be affected by dynamic power context switching.

FIG. 6A is a circuit diagram of an illustrative in-rush current limiting circuit that includes a digitally controlled current ramping digital-to-analog converter (DAC) in accordance with an embodiment.

FIG. 6B is a timing diagram illustrating the operation of an in-rush current limiting circuit of the type shown in FIG. 6A in accordance with an embodiment.

FIG. 7A is a circuit diagram of an illustrative in-rush current limiting circuit that implements analog linear current ramping in accordance with an embodiment.

FIG. 7B is a timing diagram illustrating the operation of an in-rush current limiting circuit of the type shown in FIG. 7A in accordance with an embodiment.

FIG. 8A is a circuit diagram of an illustrative in-rush current limiting circuit that implements negative current feedback in accordance with an embodiment.

FIG. 8B is a timing diagram illustrating the operation of an in-rush current limiting circuit of the type shown in FIG. 8A in accordance with an embodiment.

FIG. 9A is a diagram of an image sensor that includes multiple bias context groups in accordance with an embodiment.

FIG. 9B is a timing diagram illustrating how tie-high/tie-low enabling signals can be delayed at power-down to allow time for the bias current to fall low in accordance with an embodiment.

### DETAILED DESCRIPTION

Embodiments of the present invention relate to image sensors, and more particularly to image sensors that employ dynamic context switching. It will be recognized by one skilled in the art, that the present exemplary embodiments may be practiced without some or all of these specific details. In other instances, well-known operations have not been described in detail in order not to unnecessarily obscure the present embodiments.

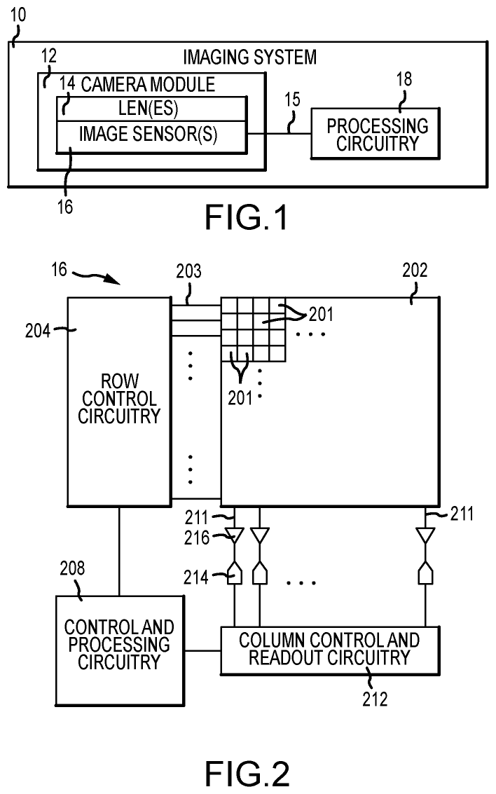

FIG. 1 is a diagram of an illustrative electronic device in accordance with an embodiment of the present invention. As shown in FIG. 1, imaging system 10 may be a portable imaging system such as a camera, automotive imaging system, cellular telephone, video camera, video surveillance system, or any other desired imaging device that captures digital image data. System 10 may include a camera module 12 that is used to convert incoming light into digital image data. Camera module 12 may include an array of lenses 14 and corresponding image sensor(s) 16. Lens(es) 14 and image sensor(s) 16 may be mounted in a common package and may provide image data to processing circuitry 18. Image sensors 16 may include one or more image sensors and lens array 14 may include one or more corresponding lenses.

Processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensor array 16 or an integrated circuit within module 12 that is associated with image sensor array 16). Image data that has been captured and processed by camera module 12 may, if desired, be further processed and stored using processing circuitry 18. Processed image data may, if desired, be provided to external equipment (e.g., a computer or other device) using wired and/or wireless communications paths coupled to processing circuitry 18.

Each pixel in image sensor(s) 16 may receive light of a given color by providing each image pixel with a color filter. The color filters that are used for image sensor pixels in the image sensors may, for example, be red filters, blue filters, and green filters. Other filters such as white color filters, dual-band IR cutoff filters (e.g., filters that allow visible light and a range of infrared light emitted by LED lights), etc. may also be used.

FIG. 2 is a diagram of an illustrative image pixel array in an image sensor As shown in FIG. 2, the image sensor (e.g., image sensor 16 of FIG. 1) may include pixel array 202 having multiple pixels 201 (sometimes referred to herein as image pixels 201 or image sensor pixels 201) and row control circuitry 204 that is coupled to image pixel array 202. Row control circuitry 204 may provide pixel control signals (e.g., row select signals, pixel reset signals, charge transfer signals, etc.) to pixels 201 over corresponding row control lines 203 to control the capture and read out of images using image sensor pixels in array 202.

Image sensor 16 may include column control and readout circuitry 212 and control and processing circuitry 208 that is coupled to row control circuitry 204 and column circuitry 212. Column control circuitry 212 may be coupled to array 202 via multiple column lines 211. For example, each column of pixels 201 in array 202 may be coupled to a respective column line 211. A corresponding analog-to-digital converter (ADC) 214 and column amplifier 216 may be interposed on each column line 211 for amplifying analog signals captured by array 202 and converting the captured analog signals to corresponding digital pixel data. Column control and readout circuitry 212 may be coupled to external hardware such as processing circuitry. Column control and readout circuitry 212 may perform column readout based on signals received from control and processing circuitry 208. Column control and readout circuitry 212 may include column ADC circuits 214 and column amplifiers 216.

Amplifier 216 may be configured to receive analog signals (e.g., analog reset or image level signals) from pixel array 202 and to amplify the analog signals. The analog signals may include data from a single column of pixels or from multiple columns of pixels, depending on the application. ADC 214 may receive amplified analog signals from amplifier 216 and may perform analog-to-digital conversion operations on the analog signals to generate digital data. The digital data may be transmitted to column control and readout circuitry 212 for processing and readout.

In general, it is desirable to minimize power consumption during image capture operations even when operating at lower speeds (e.g., at a low frame rate or high frame time). For a rolling shutter image sensor where a still picture or a video frame is not captured by taking a single snapshot of the entire frame but rather by scanning across the frame rapidly in a row-by-row fashion (as an example), one way of minimizing power consumption is to keep the readout pace (or “line rate”) identical to the full-speed mode while turning off the analog bias current in between successive read cycles. This effectively introduces low power “dummy lines” to fill up the increased frame time.

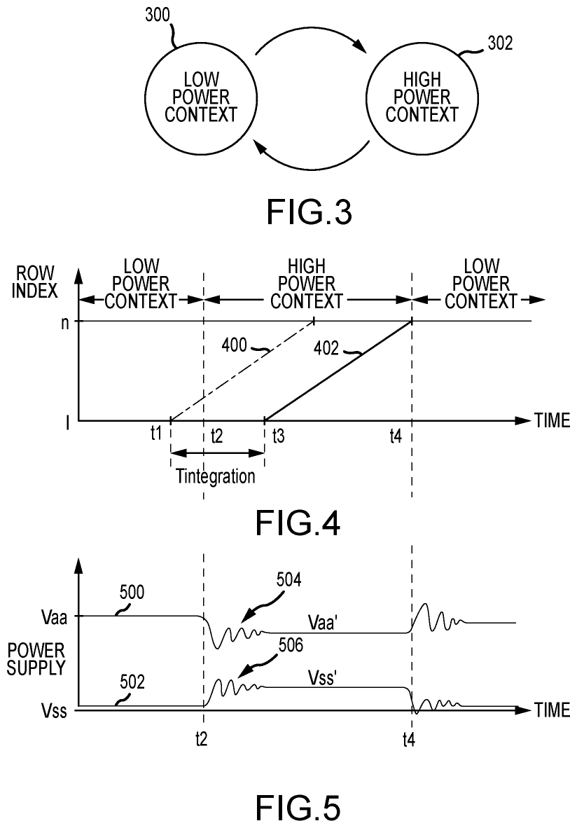

The rolling shutter readout pointer should overlap with the high-power state where the analog bias current is switched on. During periods corresponding to the dummy lines, the image sensor can be switched to a lower-power state where the analog bias current is switched off. The transition between the high-power state and the low-power state is sometimes referred to as “dynamic power context switching,” which is illustrated in FIG. 3. As shown in FIG. 3, the image sensor can switch between a low-power context (or state) 300 and a high-power context (or state) 302. During low-power context 300, the bias current that is supplied to the peripheral control circuitry (e.g., column control and readout circuitry 212 and associated column amplifiers 216 and ADC 214, row control circuitry 204, etc.) may be driven to a low value. During high-power context 302, the bias current supplied to the peripheral control circuitry may be driven to its normal high value.

FIG. 4 is a timing diagram illustrating dynamic power context switching. Line 400 represents the integration start time for different rows in the rolling shutter image sensor (e.g., for rows 1-n), whereas line 402 represents the readout pointer for each row in the array. Thus, the time period between the line 400 and line 402 for any given row represents the integration time. In the example of FIG. 4, time t1 denotes the integration start time for the first row in the pixel array, whereas time t3 denotes when the first row will be read out. Thus, the time period between t1 and t3 represents the integration time (Tintegration), which should be the same for each row in the image pixel array.

As shown in FIG. 4, the integration start event could overlap with the low-power context and the high-power context. In FIG. 4, the image sensor switches from the low-power context 300 to the high-power context 302 at time t2 and switches from the high-power context 302 back down to the low-power context 300 at time t4 after the entire frame has been read out.

FIG. 5 is a timing diagram illustrating how the power supply network can be affected by the dynamic power context switching. Trace 500 represents the positive power supply voltage on the power supply network, whereas trace 502 represents the ground power supply voltage on the power supply network. At time t2 when the image sensor switches from the lower-power state to the high-power state (sometimes referred to as “powering-up”), trace 500 may fall from nominal power supply voltage level Vaa down to reduced voltage level Vaa' while suffering from rippling/ringing 504. Similarly, trace 502 may rise from nominal ground supply level Vss up to an elevated voltage level Vss' while suffering from rippling/ring 506. The same power supply rippling/ringing could also occur at time t4 when the image sensor switches from the high-power state to the low-power state (sometimes referred to as “powering-down”).

This ringing or unintended spikes at the power supply network could cause a dark reference level to be inadvertently sampled by the pixels during integration. Typical four-transistor (4T) rolling shutter pixels can be read out using a correlated double sampling (CDS) scheme where noise/offset can be canceled out by subtracting an image signal from a known reference level. However, some rolling shutter pixels such as pixels that support multiple gain modes (e.g., high dynamic range rolling shutter pixels) cannot fully rely on CDS, so any shift in the pixel dark reference level will be visible in the final output. Moreover, artifacts caused by the power supply voltage rippling is generally hard to correct via external fixed pattern noise (FPN) correction, as one would need to store dark reference images for each combination of frame rate and integration time. Applying a real-time offset correction with a mechanical shutter each time the camera configuration changes (i.e., whenever the frame rate and integration time changes) is not an acceptable solution in most applications.

In accordance with an embodiment, a scheme is provided to control and soften the power context switching itself by gradually ramping up the current demand in a way so that the power supply network suffers from minimal rippling/ringing. By keeping the in-rush bias current under control during dynamic power context switching, the image quality will be improved by preventing any shutter artifacts, the power consumption will be reduced by allowing systems to engage dynamic power context switching without having to worry about degrading the image quality, and the cost is also reduced since a less complex power management unit is needed.

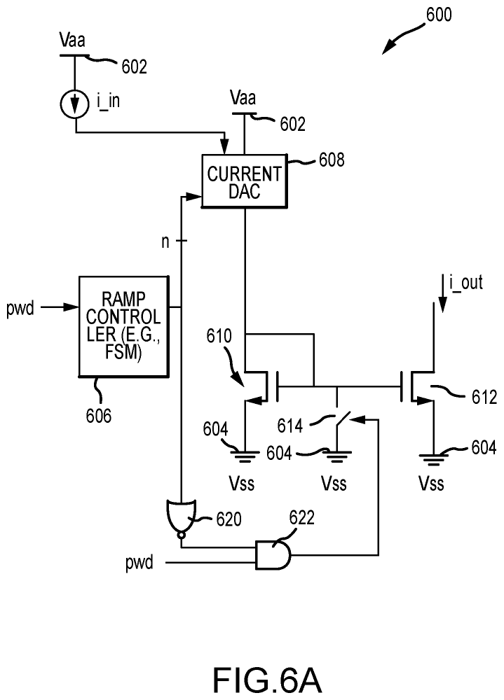

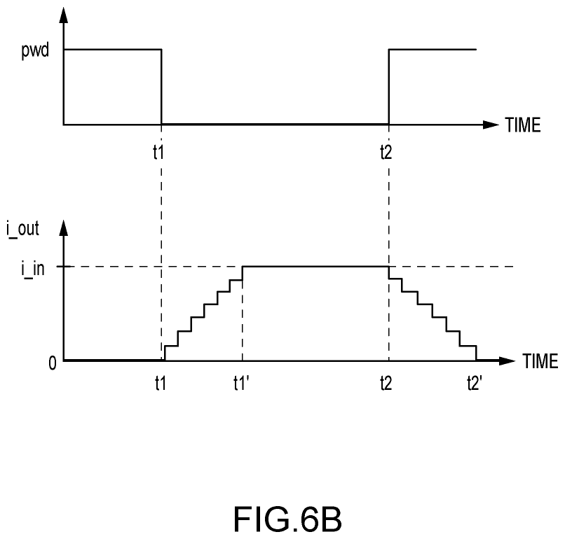

FIG. 6A is a circuit diagram of an illustrative in-rush current limiting circuit 600 that can be used to gradually ramp up the bias current during dynamic power context switching events. In-rush current limiting circuit 600 may be considered as part of control and processing circuitry 208, the column control circuitry, or the row control circuitry on the image sensor. As shown in FIG. 6A, current limiting circuit 600 may include a current source i_in that draws current from positive power supply line 602 (e.g., a positive power supply terminal on which positive power supply voltage Vaa is provided), a current digital-to-analog converter (DAC) 608, a ramp controller 606 that controls the current DAC 608, a first transistor 610 connected in series with the current DAC 608 between power supply line 602 and ground line 604 (e.g., a ground power supply line on which ground voltage Vss is provided), and a second transistor 612 coupled to the first transistor 610.

Transistors 610 and 612 may be n-type metal-oxide-semiconductor (NMOS) transistors, n-channel transistors, or other suitable types of pull-down transistors. In particular, transistor 610 may have a gate terminal and a drain terminal shorted to its gate terminal and is sometimes referred to as being a “diode-connected” transistor. Transistor 612 has a gate terminal shorted to the gate terminal of the transistor 610 and a source terminal connected to ground line 604. The drain terminal of transistor 612 serves as the output port of in-rush current limiting circuit 600 on which bias current i_out is provided. Configured in this way, bias current i_out will mirror whatever current is flowing through transistor 610 (e.g., transistors 610 and 612 are connected in a “current mirror” arrangement). Bias current i_out may be supplied to the peripheral control circuitry (e.g., column control and readout circuitry 212 and associated column amplifiers 216 and ADC 214, row control circuitry 204, etc.) on the image sensor.

Ramp controller 606 may have an input that receives a power-down signal (pwd). FIG. 6B shows relevant waveforms illustrating the operation of current limiting circuit 600. When signal pwd is asserted (e.g., when pwd is driven high before time t1), ramp controller 606 is disabled and may output a constant low digital value at its output. When ramp controller 606 outputs a low digital value, current DAC 608 may only output a low or zero current onto transistor 610. Since current DAC 608 is not outputting any current, the bias current i_out output from circuit 600 will be low (e.g., zero amps). Note that during this time, asserting signal pwd will turn on switch 614, which will pull the gate terminals of transistors 610 and 612 down to ground, effectively turning off both of transistors 610 and 612.

At time t1, signal pwd is deasserted (e.g., pwd is driven low). In response to deasserting signal pwd, ramp controller 606 (e.g., a finite state machine that is able to count up) will output increasing digital values at fixed time steps. This will direct current DAC 608 to start increasing the amount of current in a discrete stepwise fashion until the maximum amount i_in is reached at time t1′. This rising staircase current behavior will be mirror onto the output current i_out. When i_in is reached, the digital output of ramp controller 606 should stop increasing. At this time, the high-power state is fully engaged. Note that during this time, deasserting signal pwd will immediately turn off switch 614, which will allow transistors 610 and 612 to be turned on.

When it is desired to switch back to the low-power state (at time t2), signal pwd may again be asserted (e.g., pwd is driven high). In response to deasserting signal pwd, ramp controller 606 will output decreasing digital values at fixed time steps. This will direct current DAC 608 to start decreasing the amount of current in a discrete stepwise fashion until i_out is back down to zero. This falling staircase current behavior will be mirror onto the output current i_out. At this time, the low-power state is fully engaged. Note that only after i_out is back down at zero, asserted signal pwd will turn on switch 614, which deactivates transistors 610 and 612. This type of gating mechanism can be implemented using (for example) logic NOR gate 620 and AND gate 622. Logic NOR gate 620 receives the output from ramp controller 606 and will only assert its output when the ramp controller output is back down at zero. Logic AND gate 622 has a first input that receives signals from the output of NOR gate 620 and a second input that receives signal pwd. Configured in this way, AND gate 622 will only turn on switch 614 when i_out is back down at zero and when signal pwd is asserted, as described above. This is merely illustrative. Other types of enabling scheme can also be used, if desired.

Ramp controller 606 and current DAC 608 can be configured to support multiple ramping profiles and speeds to provide increased flexibility. The ramp-up and ramp-down profile can be the same or different. The slope or “softness” of the ramping profile may be determined by the size of the current DAC. For example, by increasing the size of current DAC 608, the number of steps can be increased, which would lengthen the ramp time and therefore further soften the in-rush current. Stepping up and down the bias current digitally using DAC 608 in this way can dramatically reduce rippling on the power supply network, which can help reduce undesired shutter artifacts and improve image quality.

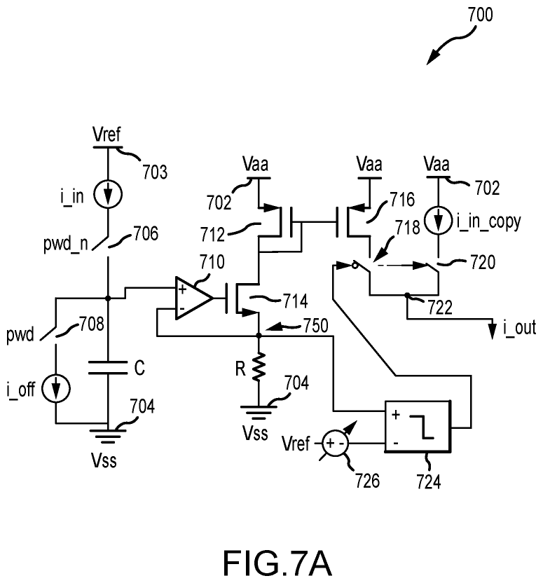

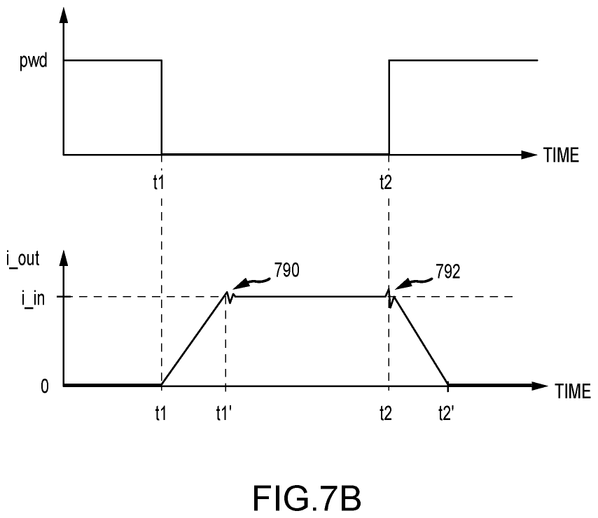

In accordance with another suitable arrangement, FIG. 7A shows an in-rush current limiting circuit 700 that implements analog linear current ramping. As shown in FIG. 7A, current limiting circuit 700 may include a current source that draws i_in from reference power supply line 703 (e.g., a positive power supply line on which reference voltage Vref is provided), a capacitor C that can be selectively charged up using current source i_in or discharged using current sink i_off, and a buffer 710 having a first (+) input that senses the amount of charge on capacitor C, a second (−) input, and an output. Circuit 700 may further include transistor 712 (e.g., a diode-connected pull-up transistor), transistor 714, and resistor R coupled in series between power supply line 702 (e.g., a positive power supply line on which nominal power supply voltage Vaa is provided) and ground line 704 (e.g., a ground power supply line on which ground voltage Vss is provided). In particular, transistor 714 (e.g., an n-type pull-down transistor) has a gate terminal connected to the output of buffer 710 and a source terminal (i.e., node 750) connected to the second (−) input of buffer 710. Connected in this way, the voltage sensed at the first (+) input of buffer 710 is transferred onto the source terminal 750 of transistor 714.

FIG. 7B shows relevant waveforms illustrating the operation of current limiting circuit 700. When signal pwd is asserted (e.g., when pwd is driven high before time t1), switch 706 is turned off to disconnect current source i_in from capacitor C while switch 708 is turned on to keep capacitor C discharged. During this time, i_out should be kept low (e.g., at zero amps).

When signal pwd is deasserted (e.g., when pwd is driven high at time t1 to transition from the low-power context to the high-power context), switch 708 is turned off and switch 706 is turned on to charge up the voltage across capacitor C. As capacitor C is charged up using current source i_in, the voltage at node 750 will follow accordingly. As the voltage at node 750 rises, the current flowing through transistor 712 (e.g., a p-type pull-up transistor) will increase proportionally. The current flowing through diode-connected transistor 712 will be mirrored across to transistor 716. As long as the voltage at node 750 is some predetermined voltage offset 726 below reference voltage level Vref, comparator 724 will output a low value, which turns on switch 718 so that transistor 716 can drive the output node 722. The predetermined voltage offset 726 might be 10 mV, 50 mV, 100 mV or some other suitable adjustable voltage delta. Operated in this way, the bias current i_out at the output node 722 will ramp up in a linear fashion as shown in FIG. 7B. The current ramp-up slope may be determined by i_in/(R*C) (as an example).

The output current i_out would stabilize at Vref/R, which should be equal to i_in. However, the value of on-die resistor R is prone to mismatch or die-to-die variation. As a result, after ramping up, it would be beneficial for the output branch to switch to a native bias current i_in_copy, which is identical to original current source i_in. To accomplish this, whenever the voltage at node 750 exceeds (Vref−offset), where the predetermined offset 726 might be 100 mV or some other suitable delta, comparator 724 would output a high value, which would turn off switch 718 while turning on switch 720 to switch the i_in_copy branch into use. This branch switching would cause a slight glitch 790 at time t1′, but the bias current i_out would settle at a predictable value i_in_copy.

To initiate the downward ramping (i.e., when transitioning from the high-power context to the low-power context at time t2), signal pwd may be reasserted. Asserting signal pwd would turn off switch 706 and turn on switch 708 to discharge the voltage across capacitor C using current sink i_off. As capacitor C is charged down using current sink i_off, the voltage at node 750 will follow accordingly. As the voltage at node 750 falls, the current flowing through transistor 712 (e.g., a p-type pull-up transistor) will decrease proportionally. The current flowing through diode-connected transistor 712 will be mirrored across to transistor 716. As soon as the voltage at node 750 drops below (Vref−offset), comparator will output a low value, which would turn off switch 720 while turning on switch 718 to switch transistor 716 into use. This branch switching would cause a slight glitch 792 at time t2, but the bias current i_out would then be allowed to ramp down linearly until i_out is zero. The current ramp-down slope may be determined by −i_off/(R*C) (as an example).

Ramping up and down the bias current linearly in this way can dramatically reduce rippling on the power supply network, which can help reduce undesired shutter artifacts and improve image quality.

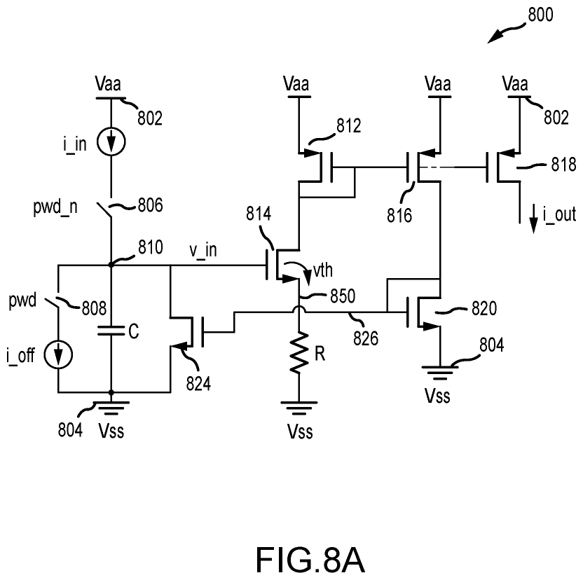

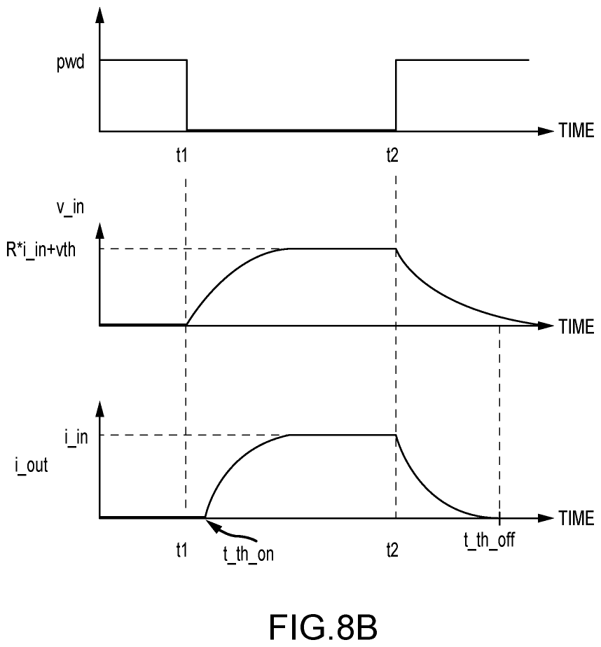

Current limiting circuit 700 of FIG. 7A may require a regulator or a bandgap voltage reference to generate reference voltage Vref. In accordance with yet another suitable arrangement, FIG. 8A shows an in-rush current limiting circuit 800 that implements an RC-type current feedback ramping scheme that does not rely on Vref generation. As shown in FIG. 8A, current limiting circuit 800 may include a current source that draws i_in from positive power supply line 802 (e.g., a positive power supply line on which positive power supply voltage Vaa is provided), a capacitor C that can be selectively charged up using current source i_in or discharged using current sink i_off, and a source follower transistor 814 (e.g., an n-type transistor) having a gate connected to the top node 810 of capacitor C. Circuit 800 may further include transistor 812 (e.g., a diode-connected pull-up transistor) and resistor R coupled in series with transistor 814 between power supply line 802 and ground line 804 (e.g., a ground power supply line on which ground voltage Vss is provided). Connected in this way, the voltage v_in sensed at the gate terminal of transistor 814 is transferred onto the source terminal 850 of transistor 814. The voltage at node 850 may generally be one transistor threshold voltage (i.e., the threshold voltage Vth of transistor 814) lower than v_in.

FIG. 8B shows relevant waveforms illustrating the operation of current limiting circuit 800. When signal pwd is asserted (e.g., when pwd is driven high before time t1), switch 806 is turned off to disconnect current source i_in from capacitor C while switch 808 is turned on to keep capacitor C discharged. During this time, i_out should be kept low (e.g., at zero amps).

When signal pwd is deasserted (e.g., when pwd is driven high at time t1 to transition from the low-power context to the high-power context), switch 808 is turned off and switch 806 is turned on to charge up the voltage across capacitor C. As capacitor C is charged up using current source i_in, the voltage at node 850 will follow accordingly. As the voltage at node 850 rises, the current flowing through transistor 812 will increase proportionally. The current flowing through diode-connected transistor 812 will be mirrored across to transistor 816. The current flowing through diode-connected transistor 812 will also be mirrored to the output port of circuit 800 as i_out using transistor 818.

Transistor 816 (e.g., a p-type pull-up transistor) is coupled in series with transistor 820 (e.g., a diode-connected n-type pull-down transistor). The amount of current flowing through diode-connected transistor 820 may be mirrored back to transistor 824 using a feedback path 826. Transistor 824 may be coupled in parallel with capacitor C. Connected in this way, as the amount of bias current i_out rises, the amount of current that is mirrored back to transistor 824 will also increase over time, which serves to absorb or subtract charge from current source i_in over time. Transistor 824 is therefore sometimes referred to as a current subtraction transistor. Operated in this way, the bias current i_out at the output port will ramp up in a non-linear RC fashion as shown in FIG. 8B. The rising bias current i_out may be a function of i_in*(1−e\hat{ }−[(t−t_th_on)/RC]), where t_th_on is the time when the source follower transistor 814 actually turns on. Voltage v_in at the gate of source follower transistor 814 will settle to (R*i_in+Vth), but bias current i_out may naturally settle to i_in, irrespective of the value of Vaa/R. Thus, neither an accurate voltage reference nor a current copying branch is necessary, which further simplifies the circuit complexity relative to the implementation of FIG. 7A.

To initiate the downward ramping (i.e., when transitioning from the high-power context to the low-power context at time t2), signal pwd may be reasserted. Asserting signal pwd would turn off switch 806 and turn on switch 808 to discharge the voltage across capacitor C using current sink i_off. As capacitor C is charged down using current sink i_off, the voltage at node 850 will follow accordingly. As the voltage at node 850 falls, the current flowing through transistor 812 will decrease proportionally. The current flowing through diode-connected transistor 812 will be mirrored across to transistor 816, which will be mirrored back to transistor 824 via transistors 816 and 820 and current feedback path 826. The cumulative amount of current discharge across capacitor C will therefore fall overtime. Operated in this way, the bias current i_out at the output port will ramp down in an RC time settling fashion. The falling bias current i_out may be a function of i_off*(1−e\hat{ }−[(t−t2)/RC]), where t2 is the time when discharge begins. Voltage v_in at the gate of source follower transistor 814 will eventually fall low, and bias current i_out may be driven low until t_th_off, which is when the source follower transistor 814 actually turns off.

Ramping up and down the bias current using negative current feedback in this way can dramatically reduce rippling on the power supply network, which can help reduce undesired shutter artifacts and improve image quality. The “soft” power transition is inherent to the internal bias system, which is simply defined by the combination of resistor R and capacitor C.

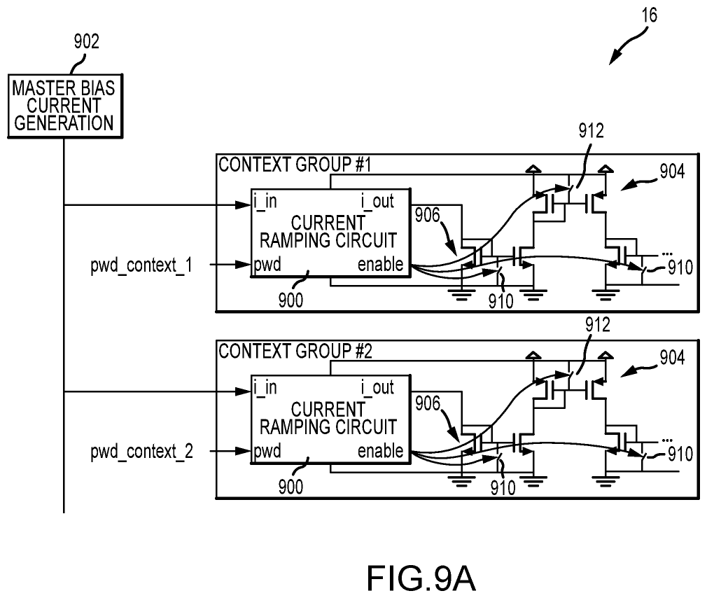

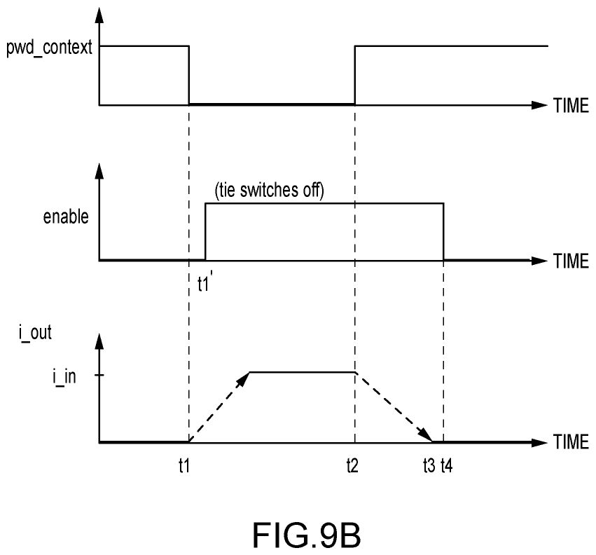

FIG. 9A is a diagram of an image sensor that includes multiple bias context groups in accordance with an embodiment. As shown in FIG. 9A, a master or global bias current generation circuit 902 may provide current source i_in to various context groups. In general, image sensor 16 may have two context groups, a single context group, more than two context groups, 2-10 bias context groups, or more than 10 bias context groups. Each context group may have its own current ramping circuit 900 (e.g., the in-rush current limiting circuit of the type described in connection with FIGS. 6-8) that receives i_in from master bias current generator 9-2 and a separate power-down control signal. For example, the first context group may be controlled by first power-down control signal pwd_context_1, whereas the second context group may be controlled by second power-down control signal pwd_context_2. The current ramping circuits 900 may be used to provide bias current i_out to circuitry 904 associated with each context group.

Still referring to FIG. 9A, circuitry 904 may be further coupled to switches 910 and 912. Switches 910 may serve as “tie-low” switches that deactivate the pull-down current paths, whereas switches 912 serve as “tie-high” switches that deactivate the pull-up current paths in circuitry 904 during the low-power context. FIG. 9B is a timing diagram illustrating how tie-high/tie-low enabling signals can be controlled during dynamic power switching events. At time t1, pwd_context is deasserted so that the image sensor is allowed to transition from the low-power state to the high-power state. An enable signal is subsequently asserted at time t1′, which turns off all of the tie-high and tie-low switches so that bias current i_out is allowed to ramp up slowly, and circuitry 904 is allowed to receive bias current i_out and function normally as intended.

At time t2, pwd_context is reasserted so that the image sensor transitions from the high-power state back down to the low-power state. The bias current i_out should be allowed to fall back low (at time t3) before deasserting the enable signal. In other words, deassertion of the enable signal is delayed until time t4. The time t4, the enable signal is deasserted, which turns on all of the tie-high and tie-low switches 910 so that circuitry 904 is deactivated.

The techniques described herein are generally suitable for rolling shutter image sensors but may in general be extended to support dynamic power context switching for any electronic application where it would be desirable to control the in-rush current and where voltage rippling/ringing/spikes at the power supply network should be minimized. If desired, all of the polarities can be flipped (e.g., the n-type and p-type transistors can be inverted). Although the methods of operations were described in a specific order, it should be understood that other operations may be performed in between described operations, described operations may be adjusted so that they occur at slightly different times or described operations may be distributed in a system which allows occurrence of the processing operations at various intervals associated with the processing, as long as the processing of the overlay operations are performed in a desired way.

In various embodiments, an image sensor is provided with an in-rush current control/limiting circuit that includes an output on which a bias current is provided, a capacitor, a current source configured to charge up the capacitor, a source follower transistor with a gate terminal connected to the capacitor, and a current subtraction transistor connected to the capacitor. The bias current is proportional to the amount of current flowing through the source follower transistor. The amount of current flowing through the source follower transistor is mirrored back to the current subtraction transistor via a negative feedback path so that the speed at which the current source charges up the capacitor decreases as the bias current increases.

In various embodiments, an image sensor is provided with an in-rush current limiting circuit that includes an output on which a bias current is provided, a capacitor, a current source configured to charge up the capacitor, a buffer configured to sense the amount of charge on the capacitor, and a pull-down transistor having a gate terminal connected to the buffer. The bias current is proportional to the amount of current flowing through the pull-down transistor, and the bias current is ramped up in a linear analog fashion. The current limiting circuit also includes a first pull-up branch configured to mirror the current flowing through the pull-down transistor, a second pull-up branch configured to receive a copy of the current source, and a comparator that determines whether the first pull-up branch or the second pull-up branch is connected to the output.

In various embodiments, an image sensor is provided with an in-rush current limiting circuit that includes a first diode-connected transistor, a second transistor configured to mirror the amount of current flowing through the first transistor, a current digital-to-analog converter configured to supply a variable amount of current to the first transistor, and a ramp controller configured to receive a power-down signal and to output increasing digital bits to the current digital-to-analog converter so that the bias current is ramped up in a stepwise or staircase fashion.

The foregoing is merely illustrative of the principles of this invention and various modifications can be made by those skilled in the art. The foregoing embodiments may be implemented individually or in any combination.

What is claimed is:

1. An in-rush current control circuit, comprising:
an output on which a bias current is provided;
a capacitor;
a current source configured to charge up the capacitor;
a source follower transistor with a gate terminal connected to the capacitor, wherein the bias current at the output is proportional to the amount of current flowing through the source follower transistor; and
a current subtraction transistor connected to the capacitor, wherein the amount of current flowing through the source follower transistor is mirrored back to the current subtraction transistor via a negative feedback path so that the speed at which the current source charges up the capacitor decreases as the bias current increases.

2. The in-rush current control circuit of claim 1, wherein the capacitor and the current subtraction transistor are connected in parallel.

3. The in-rush current control circuit of claim 1, further comprising:
a current sink configured to discharge the capacitor, wherein at most one of the current source and current sink is actively connected to the capacitor at any point in time.

4. The in-rush current control circuit of claim 3, further comprising:
a first switch connected in series with the current source; and
a second switch connected in series with the current sink, wherein the first and second switches are controlled by a power-down signal.

5. The in-rush current control circuit of claim 1, wherein the bias current is ramped up in a non-linear analog fashion.

6. The in-rush current control circuit of claim 1, further comprising:
a resistor connected in series with the source-follower transistor.

7. The in-rush current control circuit of claim 6, further comprising:
a first pull-up transistor connected in series with the source-follower transistor, wherein the first pull-up transistor is diode-connected.

8. The in-rush current control circuit of claim 7, further comprising:
a second pull-up transistor that mirrors the current of the first pull-up transistor; and
a pull-down transistor connected in series with the second pull-up transistor, wherein the pull-down transistor is diode-connected.

9. The in-rush current control circuit of claim 8, wherein the pull-down transistor and the current subtraction transistor have gate terminals that are shorted to one another.

10. The in-rush current control circuit of claim 9, further comprising:
a third pull-up transistor that mirrors the current of the first pull-up transistor, wherein the bias current flows through the third pull-up transistor.

11. An in-rush current control circuit, comprising:
an output on which a bias current is provided;
a capacitor;
a current source configured to charge up the capacitor;
a buffer configured to sense the amount of charge on the capacitor; and
a pull-down transistor having a gate terminal connected to the buffer, wherein the bias current at the output is proportional to the amount of current flowing through the pull-down transistor, and wherein the bias current is ramped up in a linear analog fashion.

12. The in-rush current control circuit of claim 11, further comprising:
a current sink configured to discharge the capacitor, wherein at most one of the current source and current sink is actively connected to the capacitor at any point in time.

13. The in-rush current control circuit of claim 12, further comprising:
a first switch connected in series with the current source; and
a second switch connected in series with the current sink, wherein the first and second switches are controlled by a power-down signal.

14. The in-rush current control circuit of claim 11, further comprising:
a comparator having a first input connected to the pull-down transistor and a second input configured to receive a reference voltage.

15. The in-rush current control circuit of claim 14, further comprising:
a first pull-up branch configured to mirror the current flowing through the pull-down transistor; and
a second pull-up branch configured to receive a copy of the current source, wherein a selected one of the first and second pull-up branches is connected to the output.

16. The in-rush current control circuit of claim 14, wherein the comparator is configured to determine whether the first pull-up branch or the second pull-up branch is connected to the output.

17. The in-rush current control circuit of claim 14, further comprising:
an adjustable voltage offset inserted at the second input of the comparator.

18. An in-rush current control circuit, comprising:
a first transistor that is diode-connected;
a second transistor configured to mirror the amount of current flowing through the first transistor; and
a current digital-to-analog converter configured to supply a variable amount of current to the first transistor.

19. The in-rush current control circuit of claim 18, further comprising:
a ramp controller configured to receive a power-down signal and to output increasing digital bits to the current digital-to-analog converter so that the bias current is ramped up in a stepwise fashion.

20. The in-rush current control circuit of claim 19, further comprising:
a switch connected to gate terminals of the first and second transistors, wherein the switch is also controlled by the power-down signal.
